(19) United States
(12) Patent Application Publication
(10) Pub. No.: US 2012/0167133 A1
(43) Pub. Date: Jun. 28, 2012

(54) DYNAMIC CONTENT INSERTION USING CONTENT SIGNATURES

(76) Inventors: John W. Carroll, Gilbert, AZ (US); C. Brendan Traw, Portland, OR (US)

(21) Appl. No.: 12/978,196

(22) Filed: Dec. 23, 2010

(51) Int. Cl. H04N 7/10

(52) U.S. Cl. 725/32

(57) ABSTRACT

In a content delivery client device, real-time dynamic content insertion into digital content may be performed by scanning the digital content by the client device, prior to rendering the digital content, to detect a content signature from the content. A server may be queried by the client device, the query including the detected content signature. In response to the query, the client device receives a first database corresponding to the detected content signature, including at least one entry for the detected content signature and at least one associated action to be performed by the client device. The client device searches the first database for the detected content signature; and performs an action associated with the detected content signature on the client device prior to rendering the digital content. The action may include inserting advertising content into the digital content.

### FIELD

The present disclosure generally relates to the field of computing and digital content distribution and usage. More particularly, an embodiment of the invention generally relates to dynamic content insertion into digital content processed by consumer electronics and computing devices.

### BACKGROUND

Digital audio/video content in the home (such as may be displayed on a television (TV) or display monitor) can take many paths through different devices from its source to the TV. Along this path, content owners may lose control over the presentation of that content—the receiving device, viewing time, and viewing audience may be unknown to either the content owner or content distributor (e.g., broadcast network, cable and satellite TV channels, etc.). This information is especially important for the delivery of advertising messages because a brand manager will want to deliver different advertising messages to different people and to know if the advertising messages were successfully delivered. To accomplish this, advertising targeting is typically done by integrating the targeting decision with each content distributor and relies on the distributor having enough information about viewers and content distribution infrastructure to support ad insertion. Ad networks attempt to solve the information problem by aggregating viewer information across content distributors, but there is no infrastructure to dynamically deliver targeting across different modes of content distribution. The main reason for this is because dynamic content insertion is traditionally done using information outside of the video stream, but content delivery fragmentation has resulted in a wide range of metadata availability and little or no standardization. The only constant across content distribution channels is that the audio/video content is delivered.

Dynamic TV ad insertion is currently done by sending “out of band” messages to set-top boxes, which can then insert appropriate ads. This may be accomplished by changing the channel, or in some cases by playing back advertising content from a local cache of ads. One problem with this approach is that it requires real-time integration into the broadcaster's head-end equipment to notify the set-top box when there are upcoming ad insertion opportunities. For Internet video, it is typically done by integrating the ad decision system with an ad network and must be done by each content provider, making the enabling effort immense because of delivery fragmentation.

An efficient infrastructure flexible enough to give content owners full control of their content until it is displayed to a viewer would be useful.

### BRIEF DESCRIPTION OF THE DRAWINGS

The detailed description is provided with reference to the accompanying figures. The use of the same reference numbers in different figures indicates similar or identical items.

FIG. 1 is a block diagram illustrating an embodiment of a digital content processing system in accordance with some embodiments of the invention.

FIG. 2 is a diagram of a global content signatures database according to an embodiment of the present invention.

FIG. 3 is a diagram illustrating a content analysis and editing system according to an embodiment of the present invention.

FIG. 4 is a flow diagram of a process for detecting content signatures and ad campaign management according to an embodiment of the present invention.

FIG. 5 is a diagram of a media processing system for performing the process of FIG. 4 according to an embodiment of the present invention.

### DETAILED DESCRIPTION

Embodiments of the present invention enable dynamic advertising insertion by a client device for content being rendered on a display. Embodiments of the present invention apply content identification technologies performed by the client device to determine the owner of content and give the content owner an opportunity to change the content before the content is displayed by the client device. When content is being played back on the TV or monitor by a client device, regardless of its source (e.g., Internet, digital video recorder (DVR), broadcast TV, cable TV or satellite TV service provider, and optical media such as DVDs and Blu-Ray disks), the content may be continuously scanned by the client device for either an identifying digital watermark or a video fingerprint prior to or contemporaneous with display of the content. Generally, at least one of a digital watermark and a video fingerprint are referred to herein as a content signature. These content signatures may then be used to query a server having a large online global content signatures database, which returns to the client device a smaller, local content signatures database containing content signatures descriptors and one or more actions to be performed when a match is detected. In an embodiment, the local content signatures database may be stored locally on the client device.

As the content is continued to be played by the client device, the signature of the content continues to be generated and the local content signatures database may be queried. When there is a match, the specified action may be taken. In an embodiment, this might include preempting playback of the original content. The action may include insertion of a targeted commercial over one embedded in broadcast content, triggering an associated advertising message such as a banner ad, interacting with a social networking application, or commencing an interactive application, for example. In an embodiment, the content inserted may be an overlay of program relevant information. Each advertising insertion decision may be made independently, with the client device dynamically and in real-time connecting to a content owner's server to update ad campaigns and to ensure the availability of the necessary advertising collateral information. In an embodiment, this advertising collateral information may be delivered ahead of time to the client device via the Internet (on the basis of the initial content signature match) so that the advertising collateral information is locally stored on the client device and ready for insertion at the best opportunity.

In some embodiments, implementation of the action by the client device may be supplemented with viewer profile information (such as user/household demographics, content viewing history, etc.) collected either within the client device or obtained externally. In some cases, such as replacing an old ad from stored content with an updated ad containing a current advertising promotion, viewer profile information may not be needed.

In embodiments of the present invention, the content owner retains full control over the ad insertion decision and may use the content owner's purchased ad inventory in any way the content owner chooses without enabling every (or any) particular content distribution network. Additionally, measurement of content/ad consumption may be done without tight integration with every ad insertion component.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software (including for example micro-code that controls the operations of a processor), or some combination thereof. Further, although steps of a process may be disclosed in a certain order, in various embodiments those steps may be rearranged or performed in parallel.

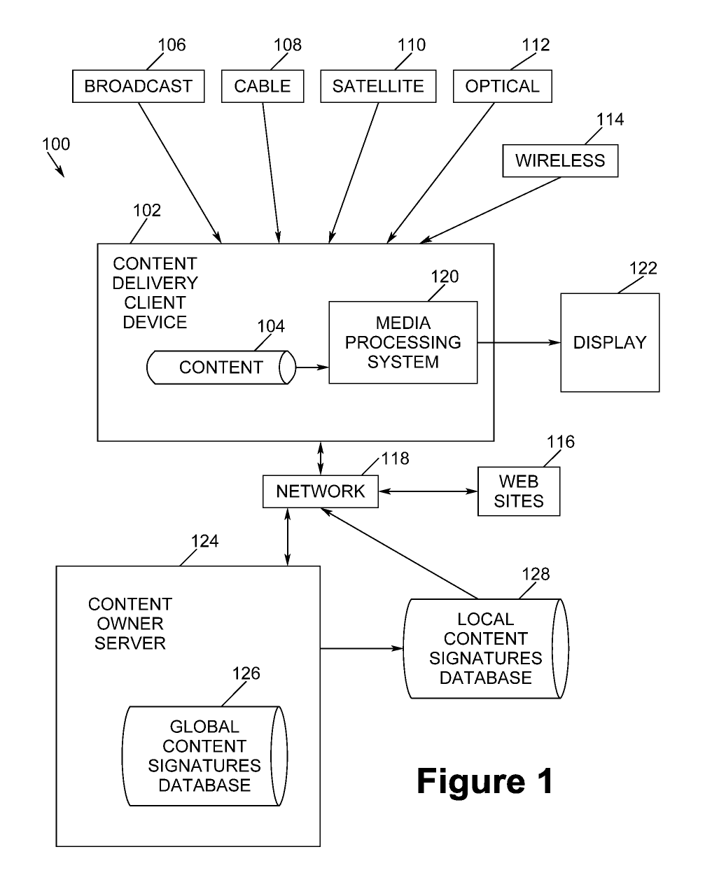

FIG. 1 is a block diagram illustrating a digital content processing system 100 in accordance with some embodiments of the invention. The digital content processing system includes a content delivery client device 102. Content delivery client device 102 comprises a device for receiving, processing, and rendering digital content 104 for audio and/or visual perception by a user. In various embodiments, the content delivery client device may comprise a cable TV or satellite TV set-top box, a television, a digital video recorder (DVR), a consumer electronics device, a tablet computing device, a cellular telephone such as a smart phone, a handheld computer, a netbook, a laptop, a personal video player (PVP), or any other device for receiving, processing and rendering digital content. Digital content 104 may comprise any combination of audio, video, or other data (such as text, graphics, etc.) received by the content delivery client device. In various embodiments, the digital content may be received from a broadcast source 106 such as a local over-the-air TV station, cable TV provider 108, satellite TV provider 110, or an optical disk 110 such as a CD-ROM, DVD, or Blu-Ray. Further, the digital content may be received over a wireless link 114 (such as a cellular communications channel or a wireless link from a home router or switch, for example). The digital content may also include data received from one or more web sites 116 with which the client device communicates over a network 118, such as the Internet. Data processing for the content delivery client device 102 may be provided by media processing system 120. Media processing system 120 may include hardware, firmware, and software to enhance seamless delivery of audio and video data to a viewer from any of the content sources. Media processing system 120 includes functional units for robust two dimensional (2D)/three dimensional (3D) graphics, flexible input/output (I/O), security and a unified high speed memory subsystem for optimal responsiveness within Internet applications. Content delivery client device 102 may be coupled to a display 122 for displaying video data to a user. In an embodiment, the display may be integral with the content delivery client device (for example, in the case of a tablet computing device, netbook, laptop, or smartphone). In another embodiment, the display may be separate from the content delivery client device, such as a TV or computer monitor.

In an embodiment of the present invention, a content owner server 124 may be communicatively coupled to the content delivery client device over network 118. In an embodiment, the network is the Internet. In other embodiments, the network may comprise a wireless communications network (such as a cellular network, for example 3G, 4G, WiMax, or Long Term Evolution (LTE)). Content owner server may be a computer server owned and/or operated by a content owner or content provider. In an embodiment, the content owner may desire to control the advertising delivered by the client device depending on which content is being received from a content source and rendered.

Content owner server 124 comprises a global content signatures database 126. The global content signatures database comprises information regarding signatures of content owned or provided by the content owner, along with owner identification information, and selected actions. In an embodiment, the global content signatures database may be a very large collection of data, too large to be efficiently stored and searched on a client device. In an embodiment, depending on what content is detected by the content delivery client device, the content owner server selects a relevant subset of the global content signatures database and sends this subset as local content signatures database 128 to the client device. In another embodiment, the local content signatures database may be selected and downloaded to the client device based at least in part on factors other than or in addition to the currently detected content. The client device may use the local content signatures database to further process the content 104 prior to display on display 122. In an embodiment, content owner server may send advertising content to the content delivery client device along with the local content signatures database. In an embodiment, the advertising content may correspond to an action specified in the local content signatures database.

In an embodiment, if the content delivery client device 102 has sufficient processing power, memory, and bandwidth, the content delivery client device may be configured to perform the processing of the content owner server 124 and store the entire global content signatures database 126 instead of a smaller subset local content signatures database 128. This global content signatures database may be periodically updated on the client device.

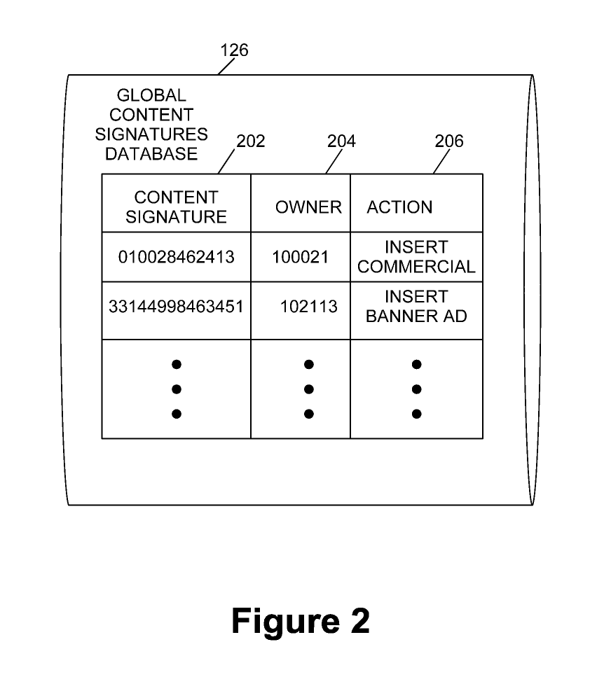

FIG. 2 is a diagram of a global content signatures database 126 according to an embodiment of the present invention. In an embodiment, global content signatures database comprises a plurality of content signatures 202. Each content signature identifies a particular item of content. In an embodiment, the content signature uniquely identifies the content. The content item may be a TV program, a feature length film, a video clip, a music video, a song, a commercial, a movie trailer, etc., or any portion thereof. Each content signature may be associated with a content owner 204, and at least one action 206 to be performed by the client device when the content signature is detected in the content to be rendered. In an embodiment, the action may be null, that is, no action. In an embodiment, the action may be to insert a new commercial advertisement into the content, overwrite an existing commercial with a new one, insert a banner ad somewhere on the display, commence interaction with a social networking application, or commence interaction with any other interactive application on the client device. In an embodiment, any program related information may be inserted into the content. Any combinations of actions may also be specified. Other actions may also be specified. In other embodiments, other data fields may also be used or omitted in the global content signatures database. In an embodiment where the global content signatures database is for content owned by a single entity, the owner field may be omitted.

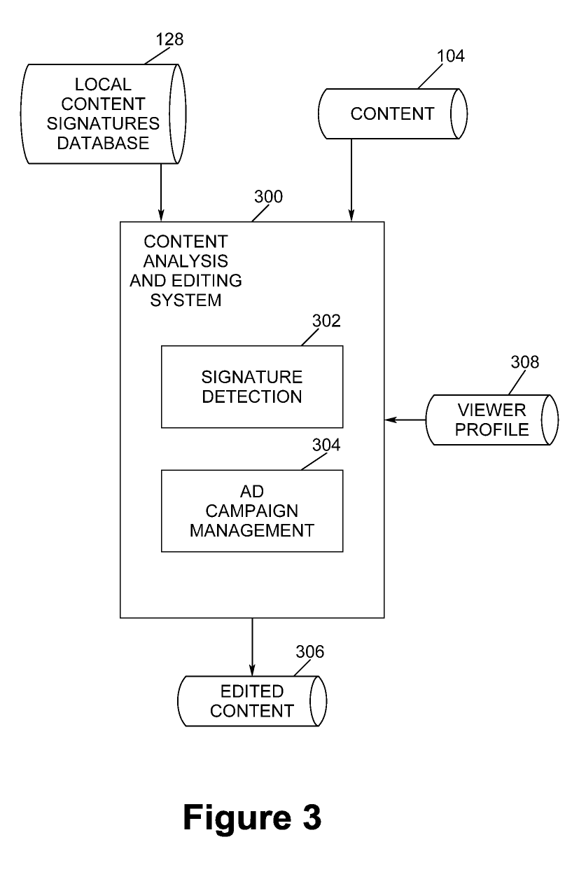

FIG. 3 is a diagram illustrating a content analysis and editing system 300 according to an embodiment of the present invention. In embodiments of the present invention, the content analysis and editing system 300 may be a component of the content delivery client device 102. A signature detection component 302 analyzes at least a portion of the content 104 prior to display of the content. The signature detection component attempts to detect a content signature in the content.

In one embodiment, the content signature comprises a digital watermark. Digital watermarking is the process of embedding information into digital content in a way that is difficult to remove. If the digital content is copied, then the information is also carried in the copy. The digital content may carry several different digital watermarks at the same time. In visible watermarking, the information is visible in the picture or video. Typically, the information is text or a logo which identifies the owner of the content. When a television broadcaster adds its logo to the corner of transmitted video, this is an example of a visible watermark. In invisible watermarking, information is added as digital data to audio, a picture or video, but it cannot be perceived as such (although it may be possible to detect that some amount of information is hidden). The digital watermark may be intended for widespread use and is thus made easy to retrieve. In either case, as in visible watermarking, the objective is to attach ownership or other descriptive information to the digital content in a way that is difficult to remove.

In an embodiment, the content owner inserts the digital watermark into the content before providing the content to a content distributor (i.e., before broadcast, multicast, unicast, or distribution on optical disks). In an embodiment, the digital watermark identifies the content and/or the content owner. Various digital watermarking techniques are known in the art and no particular implementation is specified herein.

In an embodiment, the content signature comprises a video fingerprint. The video fingerprint may be generated by the content analysis and editing system from any combination of audio, video, and audio and video content. The video fingerprint comprises a representation of the content such that the representation identifies the content and/or content owner. Video fingerprinting is a technique in which a processing component (implemented either in hardware or software) identifies, extracts and then compresses characteristic components of video content, enabling that video content to be uniquely identified by its resultant fingerprint. Video fingerprinting is a known technology that has proven to be effective at identifying and comparing digital video data. Video fingerprinting analysis may be based on any number of visual video features including, but not limited to, key frame analysis, and color and motion changes during a video sequence.

In various embodiments, the video fingerprint may be generated from the first second or portion thereof of the content, the first few seconds of the content, or may be periodically or continuously sampled from portions of the content as the content is rendered. Various video fingerprinting techniques are known in the art and no particular implementation is specified herein.

Regardless of whether the content signature is a digital watermark or a video fingerprint, when the signature detection component 302 detects the content signature while processing the content, the signature detection component notifies ad campaign management component 304. Ad campaign management component 304 uses the content signature as an index into the locally stored local content signatures database 128. When the appropriate entry in the local content signatures database is found, the ad campaign management component may perform the action specified for this content. That is, the ad campaign management component may modify the content 104 in any way specified at least in part by the action obtained from the local content signatures database to produce edited content 306. Edited content 306 may then be rendered on the display for the viewer. In an embodiment, the ad campaign management component may be more generally referred to as a content insertion management component.

In an embodiment, actions may be based at least in part on a viewer profile 308. Viewer profile may be maintained on the client device or obtained from an external source. Viewer profile may describe the demographics of viewers in the household, or individual users of the client device. Depending on the information stored in the viewer profile (such as gender and age of the viewer, geographic location, past viewing habits, interests, etc.), the specified actions may be amended to include, for example, deleting objectionable scenes from a video, changing product advertisements based on a viewer age and/or gender, and so on. In general, the viewer profile information may be used to modify the specified action from the local content signatures database prior to performing the action.

In an embodiment, editing the content may be performed at least in part based on date and time. For example, an ad for a local store advertising a sale for a specified period of time may need to be refreshed or deleted. In various embodiments, updating of the local content signatures database may be performed at different times (for example, when any content signature is first detected, when a program starts, every hour, every day, etc.).

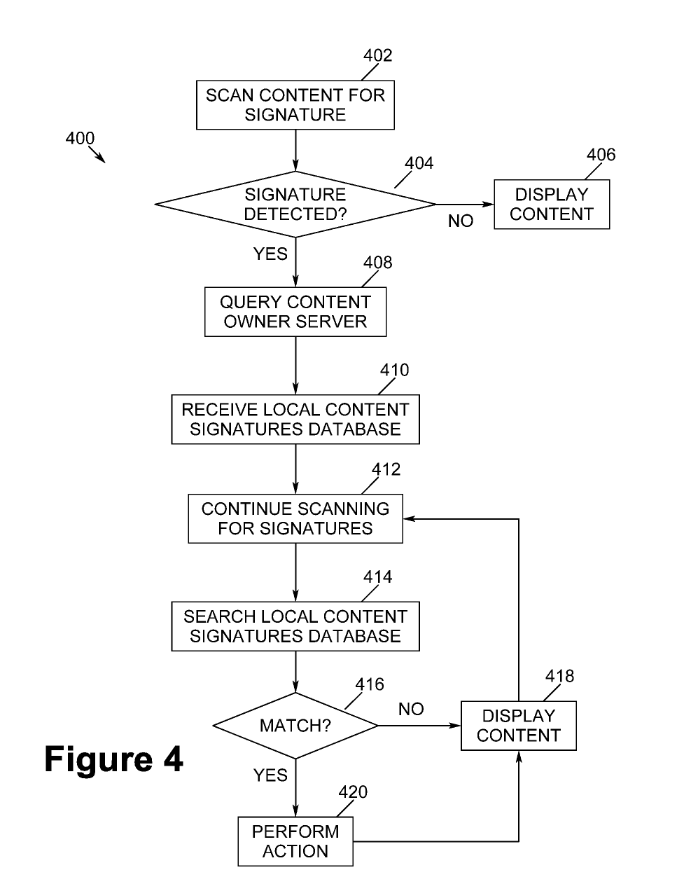

FIG. 4 is a flow diagram of a process 400 for detecting content signatures and ad campaign management according to an embodiment of the present invention. At block 402, the signature detection component of the content analysis and editing system within the client device scans the content for a signature identifying the content. In an embodiment, the scanning activity may start to be performed when the content is begun to be processed by the client device 102 for rendering on the display. If no signature is detected in the content at block 404, then the content may be displayed without modification at block 406. If a signature is detected at block 404, then at block 408 the ad campaign management component of the client device may query content owner server 124. In an embodiment, the query includes the detected content signature. In an embodiment, the query may include an identifier of the content that has been detected by the signature scanning activity.

In an embodiment, the query includes the source of the content. In this embodiment, the content owner may tailor the response in the local content signatures database depending on which content source was used to deliver the content to the client device. That is, the action specified may be different depending on which content source provided the content to the client device. For example, one action may be specified to be performed when the content source is cable or satellite TV or broadcast TV, but another, different action may be specified to be performed when the content source is optical media. Further, yet another, different action may be specified when the content source is a DVR, or the Internet, for example.

In response to the query, the content owner server may select a subset of the global content signatures database to be the local content signatures database for this client device at this point in time. The content owner server sends the local content signatures database to the client device, which receives and stores the local content signatures database at block 410. In an embodiment, the signature detection component may continue scanning the content at block 412 to detect other content signatures. In an embodiment, this may be performed in parallel on a processing thread on the client device independent and separate from other processing threads being performed (such as for content rendering, communications, etc.).

At block 414, in an embodiment, the ad campaign management component searches the stored local content signatures database to locate the entry corresponding to the identified content. In an embodiment, the index to the database may be the detected content signature. If there is no matching entry in the local content signatures database at block 416, then no editing of the content need be performed and the content is displayed at block 418. If there is a matching entry in the local content signatures database at block 416, then the ad campaign management component reads the desired action from the local content signatures database and performs the action. The action may involve editing the content prior to display, replacing the content with new content obtained from the content owner server of from any other source of content, or any other task on the client device. In an embodiment, the client device may contact another entity as a result of the action. For example, statistics of ad insertion activity on the client device may be collected by a third party.

At block 418, the content may be displayed. Processing may continue with continued scanning of content at block 412. For example, scanning of portions of a TV program may be done on a frequency of every few minutes to detect commercials, however, scanning of portions of a feature length film or a “commercial free” program may be done only at the beginning of the film or program.

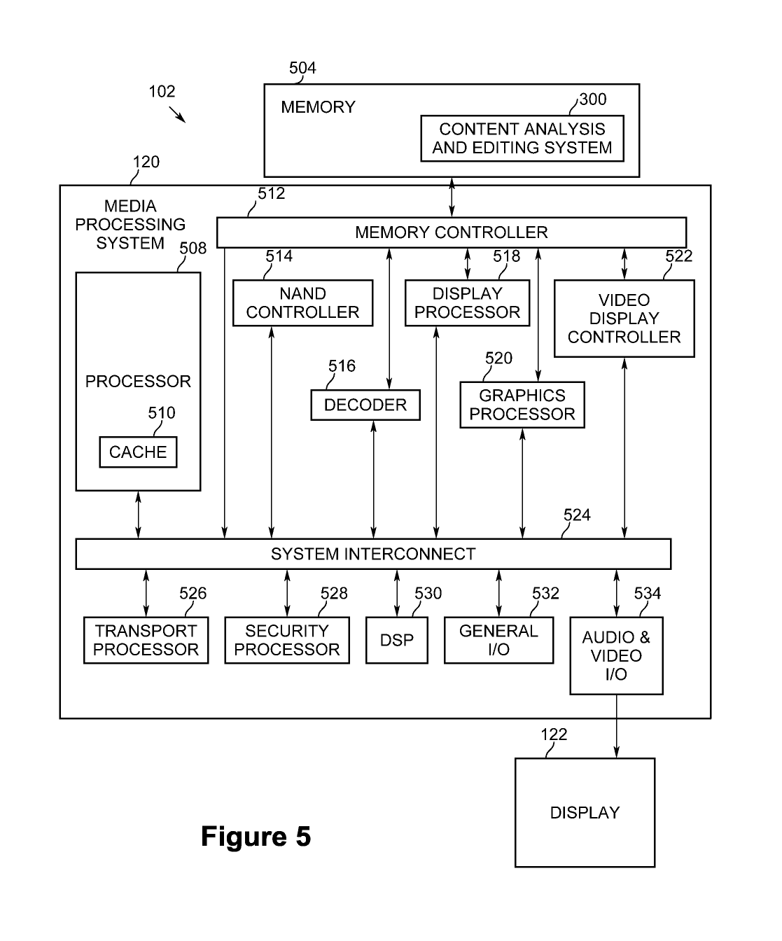

FIG. 5 illustrates a block diagram of an embodiment of a content delivery client device 102. In various embodiments, one or more of the components of the device 102 may be provided in various electronic devices capable of performing one or more of the operations discussed herein with reference to some embodiments of the invention. For example, one or more of the components of the device 102 may be used to perform the operations discussed with reference to FIGS. 1-4, including the content analysis and editing system, e.g., by processing instructions, executing subroutines, etc. in accordance with the operations discussed herein. Some components of the client device have been omitted for clarity. Also, various storage devices discussed herein (e.g., with reference to FIG. 5) may be used to store data, operation results, etc. In one embodiment, data may be stored in caches 510 present in processor 508 of media processing system 120 or in memory 504. The processor 508 may then apply the operations discussed herein to dynamically perform ad insertion in accordance with various embodiments of the invention. In an embodiment, media processing system may be implemented as “system on a chip” (SOC) and comprise a single integrated circuit die. In an embodiment, media processing system 120 may be designed to meet design requirements of Internet Protocol (IP) television and/or hybrid set-top boxes, and connect audio/video products.

Various operations discussed herein may be performed by processor 508 in some embodiments. Processor 508 may include a general purpose processor, or other types of a processor (including a reduced instruction set computer (RISC) processor or a complex instruction set computer (CISC)). Processor 508 may have a single or multiple core design. Processors 508 with a multiple core design may integrate different types of processor cores on the same integrated circuit (IC) die. Also, the processors 508 with a multiple core design may be implemented as symmetrical or asymmetrical multiprocessors. Moreover, some of the operations discussed with reference to FIGS. 1-4 may be performed by one or more components of the media processing system 120.

Memory 504 may store data, including sequences of instructions that are executed by the processor 508, or by any other device included in the media processing system 120. Furthermore, memory 504 may store one or more of the programs or algorithms discussed herein such as content analysis and editing system 300, instructions corresponding to executables, mappings, etc. The same or at least a portion of this data (including instructions) may be stored in a hard disk drive (not shown in FIG. 5) and/or one or more caches within processors 508. In one embodiment of the invention, the memory 504 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk.

In an embodiment, content analysis and editing system 300 may be implemented as a hardware component within content delivery client device 102. In an embodiment, the content analysis and editing system may be coupled to either the memory controller 512 or system interconnect 524.

In an embodiment, media processing system 120 may include a memory controller 512 to interface with memory 504 and other components internal to the media processing system. System interconnect 524 comprises a bus for interconnecting components within the media processing system. NAND flash controller 514 may be coupled to a NAND storage device (not shown) for purposes of secure booting and code/data storage and to system interconnect 524. A multi-format hardware decoder 516 may be included to decode single stream and multi-stream video data in various well known formats. In an embodiment, decoder performs multi-stream decode and display of up to 1920×1080p at 60 frames per second and single stream decode and display at approximately twice that rate. Display processor 518 may provide scaling, noise reduction, and motion adaptive de-interlacing operations on video data. Graphics processor 520 may provide a three dimensional (3D) shader architecture. Video display controller 522 may provide universal planes supporting both video and graphics pixels, blending operations supporting sideband, global, and per-pixel alpha blending per plane, and scaling operations. Transport processor 526 may provide programmable transport demux and two serial transport stream interfaces. Security processor 528 may provide two smart card interfaces, high definition content protection (HDCP) for high definition media interface (HDMI) data transfers, and hardware acceleration of security processing. Digital signal processor (DSP) 530 may support audio decoding operations. General input/output (I/O) 532 may support connections over well known interfaces such as universal serial bus (USB), serial advanced technology attachment (SATA), and Ethernet, and may connect to computer networks such as the Internet. Audio and Video I/O 534 may provide an interface to display 122 for output of video data as well as an interface to speakers (not shown) for audio output.

In an embodiment of the invention, display 122 may be a flat panel display that communicates with audio and video I/O 534 through, for example, a signal converter that translates a digital representation of an image stored in a storage device such as video memory or system memory into display signals that are interpreted and displayed by the display 122. The display signals produced by the audio and video I/O 534 may pass through various control devices (not shown for simplicity) before being interpreted by and subsequently displayed on the display 406.

Content delivery client device 102 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, or other types of nonvolatile machine-readable media that are capable of storing electronic data (e.g., including instructions).

In various embodiments of the invention, the operations discussed herein, e.g., with reference to FIGS. 1-4, may be implemented as hardware (e.g., logic circuitry), software (including, for example, micro-code that controls the operations of a processor such as the processors discussed with reference to FIG. 5), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

Thus, a system has been described herein for content owners to optimize/personalize content delivery across an unlimited number of distribution networks including, cable, satellite, terrestrial broadcast, Internet, DVRs, and optical media sources. By applying digital watermarking and/or video fingerprinting according to embodiments of the present invention, an advertiser or content owner may broadcast a single version of content, deliver a personalized version with different advertisements, or even deliver alternative content to viewers across distribution channels. The content owner may update the delivered content at any time by working with a client device provider or a single consortium representing all devices, and not have to engage multiple distributors. Further, this real-time dynamic advertising insertion technique is effective even when the content source is optical media or a DVR.

1. A method of real-time dynamic content insertion in a client device comprising:
scanning digital content by the client device, prior to rendering the digital content, to detect a content signature from the content, the detected content signature identifying the digital content;
querying a server coupled to the client device over a network, the query including the detected content signature;
receiving, in response to the query, a first database corresponding to the detected content signature, the first database including at least one entry for the detected content signature and at least one associated action to be performed by the client device;
searching the first database for the detected content signature; and
performing the at least one action associated with the detected content signature on the client device prior to rendering the digital content.

2. The method of claim 1, wherein performing the at least one action comprises editing the digital content prior to rendering by inserting advertisement content into the digital content.

3. The method of claim 2, further comprising obtaining the advertisement content from the server by the client device.

4. The method of claim 1, wherein performing the at least one action comprises replacing at least a portion of the digital content with additional content obtained from the server.

5. The method of claim 1, wherein performing the at least one action comprises commencing an interactive application on the client device.

6. The method of claim 1, wherein the query comprises a source of the digital content, and the at least one associated action is different dependent on the content source.

7. The method of claim 1, wherein the content signature comprises a digital watermark, and scanning the digital content comprises scanning for the digital watermark in the digital content.

8. The method of claim 1, wherein the content signature comprises a video fingerprint, and scanning the digital content comprises generating the video fingerprint for the digital content.

9. The method of claim 1, wherein the first database is a subset of a larger, second database stored on the server, the method further comprising storing the first database on the client device.

10. The method of claim 9, wherein each entry of the second database associates a content owner with a content signature.

11. The method of claim 1, further comprising reading viewer profile information from a viewer profile of the client device, and modifying the action based at least in part on the viewer profile information prior to performing the action.

12. A computer-readable medium comprising one or more instructions that when executed on a processor configure the processor to perform real-time dynamic content insertion in a client device by:
scanning digital content by the client device, prior to rendering the digital content, to detect a content signature from the digital content, the detected content signature identifying the content;
querying a server coupled to the client device over a network, the query including the detected content signature;
receiving, in response to the query, a first database corresponding to the detected content signature, the first database including at least one entry for the detected content signature and at least one associated action to be performed by the client device;
searching the first database for the detected content signature; and
performing the at least one action associated with the detected content signature on the client device prior to rendering the digital content.

13. The computer-readable medium of claim 12, wherein instructions to perform the at least one action comprises instructions to edit the digital content prior to rendering by inserting advertisement content into the digital content.

14. The computer-readable medium of claim 13, further comprising instructions to obtain the advertisement content from the server by the client device.

15. The computer-readable medium of claim 12, wherein instructions to perform the at least one action comprises instructions to replace at least a portion of the digital content with additional content obtained from the server.

16. The computer-readable medium of claim 12, wherein instructions to perform the at least one action comprises instructions to commence an interactive application on the client device.

17. The computer-readable medium of claim 12, wherein the query comprises a source of the digital content, and the at least one associated action is different dependent on the content source.

18. The computer-readable medium of claim 12, wherein the content signature comprises a digital watermark, and instructions to scan the digital content comprise instructions to scan for the digital watermark in the digital content.

19. The computer-readable medium of claim 12, wherein the content signature comprises a video fingerprint, and instructions to scan the digital content comprise instructions to generate the video fingerprint for the digital content.

20. The computer-readable medium of claim 12, wherein the first database is a subset of a larger, second database stored on the server, further comprising instructions to store the first database on the client device.

21. The computer-readable medium of claim 20, wherein each entry of the second database associates a content owner with a content signature.

22. The computer-readable medium of claim 12, further comprising instructions to read viewer profile information from a viewer profile of the client device, and to modify the action based at least in part on the viewer profile information prior to performing the action.

23. A content delivery client device comprising:
a display; and
a content analysis and editing system for real-time dynamic content insertion, including
a signature detection component to scan digital content, prior to rendering the digital content on the display, to detect a content signature from the digital content, the detected content signature identifying the content, and;
a content insertion management component to query a server coupled to the client device over a network, the query including the detected content signature to receive, in response to the query, a first database corresponding to the detected content signature, the first database including at least one entry for the detected content signature and at least one associated action to be performed by the client device, to search the first database for the detected content signature; and to perform the at least one action associated with the detected content signature prior to rendering the digital content on the display.

24. The content delivery client device of claim 23, wherein the content insertion management component performs the at least one action by editing the digital content prior to rendering by inserting advertisement content into the digital content.

25. The content delivery client device of claim 23, wherein the content insertion management component performs the at least one action by commencing an interactive application on the client device.

26. The content delivery client device of claim 23, wherein the query comprises a source of the digital content, and the at least one associated action is different dependent on the content source.

27. The content delivery client device of claim 23, wherein the content signature comprises a digital watermark, and the signature detection component scans for the digital watermark in the digital content.

28. The content delivery client device of claim 23, wherein the content signature comprises a video fingerprint, and the signature detection component generates the video fingerprint for the digital content.

29. The content delivery client device of claim 23, wherein the content insertion management component is configured to read viewer profile information from a viewer profile of the client device, and modify the action based at least in part on the viewer profile information prior to performing the action.
